(19) United States
(12) Patent Application Publication
(10) Pub. No.: US 2022/0051160 A1
(43) Pub. Date: Feb. 17, 2022

(54) Applied artificial intelligence system and method for constraints discovery and compliance using conversations

(71) Applicants: Yevgeniy Ivanovich Shadrin, Torrance, CA (US); Ravi Gordandas Advani, Torrance, CA (US)

(72) Inventors: Yevgeniy Ivanovich Shadrin, Torrance, CA (US); Ravi Gordandas Advani, Torrance, CA (US)

(73) Assignees: Yevgeniy Ivanovich Shadrin, Torrance, CA (US); Ravi Gordandas Advani, Torrance, CA (US)

(21) Appl. No.: 17/402,605

(22) Filed: Aug. 15, 2021

Related U.S. Application Data
(60) Provisional application No. 62/706,420, filed on Aug. 15, 2020.

(51) Int. Cl. G06Q 10/06; G06N 5/02; G06N 20/00; G06K 9/62

(52) U.S. Cl. CPC G06Q 10/06375; G06K 9/628; G06N 20/00; G06N 5/022

(57) ABSTRACT

The disclosure provides details of a computer system, method, and computer-readable medium for a computer processor to discover constraints that may apply to a business entity, for a given business profile and business circumstance. The computer system receives data from a user in a conversational manner. The computer system applies the received data to machine learning classifiers trained to determine plurality of constraints relevant to the business profile and business circumstance. The constraints identified in this manner may include but not limited to standards, procedures, policies, rules, and regulations. The computer system applies the determined plurality of constraints to create and drive a compliance journey to accelerate business entity compliance. The computer system estimates economic impact related to compliance and non-compliance of the business entity.

### TECHNICAL FIELD

The present disclosure relates to application of natural language processing (NLP), machine learning classification, knowledge graph and conversational approaches regarding discovery of internal and external business constraints and compliance thereafter.

### BACKGROUND

In the current era of Industry 4.0 enterprises strive to bring products to market at a fast pace. However, rapidly changing internal company policies, regulatory situation and market environment impose several constraints on the operating environment and business processes. This is true in almost every part of the world, and for many sectors of the economy. Given the global nature of supply chain and consumer locations, globally connected enterprises face extreme challenges and tremendous financial burden to be compliant with the constraints imposed. Visionary leaders turn to technology innovations to discover constraints that impact their business, overcome the constraints by putting in place processes for compliance and enable quick rollout of products and services while reducing cost burden.

Further, utilizing a conversational approach for interactions with computer systems is a desirable trend and usability advantage.

In view of the foregoing, it is desirable to automate processing of business-related data to accelerate compliance and use a conversational approach to interact with the user. These and more advantages will be clear as in the provided disclosure.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In one aspect, the disclosure provides details of a computer system, method, and computer-readable medium for a computer processor to discover constraints that may apply to a business entity, for a given business profile and business circumstance.

In another aspect, the computer system receives data from a user in a conversational manner.

In yet another aspect, the computer system applies the received data to machine learning classifiers trained to determine plurality of constraints relevant to the business profile and business circumstance. The constraints identified in this manner may include but not limited to standards, procedures, policies, rules, and regulations.

In yet another aspect, the computer system applies the determined plurality of constraints to create and drive a compliance journey to accelerate business entity compliance.

In yet another aspect, the computer system estimates economic impact related to compliance and non-compliance of the business entity.

### BRIEF DESCRIPTION OF THE DRAWINGS

In the following descriptions like parts are marked with the same numerals throughout the specification and drawings. In the interest of clarity and conciseness, the drawing figures are not necessarily drawn to scale, and certain figures may be shown in exaggerated or generalized form. The disclosure itself, however, will be best understood when read in conjunction with the accompanying drawings, wherein:

FIG. 1 is a schematic view of a system for discovery of constraints and personalized outcomes including constraints, economic impact and compliance journey relevant to the input data.

FIG. 2 is a schematic view of a system for discovery of constraints and personalized outcomes including constraints, economic impact and compliance journey relevant to input data for the Manufacturing industry domain according to an example embodiment.

FIG. 3 is a schematic view of the operating environment for processing data from information sources of constraints and domain data according to an example embodiment.

FIG. 4 is a process flow diagram that uses a trained model to determine plurality of constraints, compliance journey and economic impact predictions in a conversational manner according to an example embodiment.

FIG. 5 is a process flow diagram that processes manufacturing data for an entity and uses a trained model to determine plurality of constraints, compliance journey and economic impact predictions, according to an example embodiment for the manufacturing domain.

FIG. 6 illustrates an exemplary model for a knowledge graph for processing business entity data, business circumstances, and constraints in accordance with aspects of the present disclosure.

### DEFINITIONS

The following includes definitions of selected terms employed in this disclosure various examples or forms of components that fall within the scope of a term and that may be used for implementation. The examples are not intended to be limiting.

“Constraints”, as used herein, in one embodiment could mean, company rules, policies, principles, and standards; in another embodiment could mean government rules and regulations; in yet another embodiment could mean local and international standards. 100201 “Regulations”, as used herein includes rules, regulations, statutes and laws of the Federal (or central), State (or Province), County (or District) and City.

“EH&S”, as used herein means Environmental Health and Safety.

“Digital media”, as used herein is data in any of the forms listed but not limited to: text, voice message as an audio file, digital image, video, motion gesture captured as a digital signal. 100231 “Channels of input”, as used herein a channel of input is a mechanism by which the System can accept data from users and other systems. 100241 “Conversational format”, as used herein includes any form of digital media with options for user to ask further questions by selecting a button, image, link or URL. For example “OSHA permits are required. Would you like to see the form 26152. <yes> or <no>”

“Manufacturing profile data”, as used herein includes descriptions of all aspects relevant to a manufacturing business such as, manufacturing locations, products, raw materials, sources of raw materials, sourcing locations, production plants, production process descriptions, quality control process descriptions, labeling and packaging, customer locations, distribution & shipment processes, post sales processes, environment health and safety processes

“Manufacturing narrative data”, as used herein is a combination of information that includes but is not limited to plurality of description of point in time circumstantial events such as establishment of a new plant, new machinery, new customer location, new product, new raw materials, new energy sources, among others, data related to supply chain or raw material, machinery, products, correspondence with business stakeholders, suppliers and customers, among others. 100271 “Manufacturing entity”, as used herein includes any company involved in the manufacture and distribution of products. 100281 “Manufacturing compliance risk”, as used herein is a combination of legal and financial penalties for failing to act under internal and external manufacturing regulations and legislature.

### DETAILED DESCRIPTION

I. System Overview

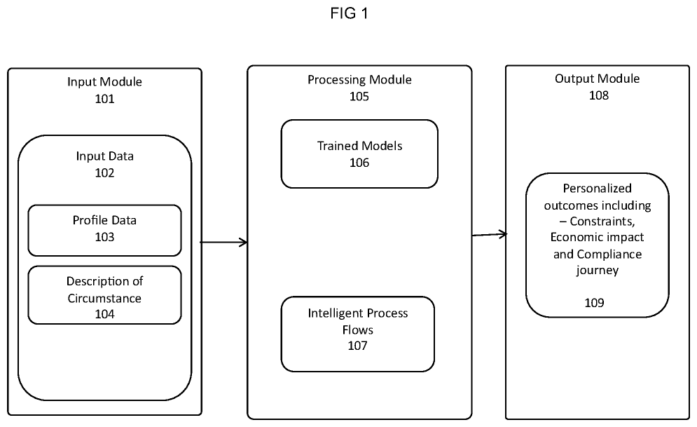

Referring to the drawings, the showings are for purposes of illustrating one or more exemplary embodiments and not for purposes of limiting the same, FIG. 1 is a schematic view of an exemplary system for discovery of constraints and accelerated personalized outcomes. To provide personalized outcomes, input module 101, as used herein, collects input data 102 which consists of profile data 103 and description of circumstance 104. The input data 102 is applied to a processing module 105, which includes trained models 106 and intelligent process flow 107. In particular, the trained models 106 output, to the output module 108, one or more personalized outcomes 109. Personalized outcomes 109 are predicted using parameters of trained models 106 and steps in intelligent process flow 107. In one embodiment, personalized outcomes 109 may include details of constraints determined and or generated by trained models 106 based on profile data 103 and description of circumstance 104. In another embodiment, personalized outcomes 109 may include report of the compliance state, estimated economic impact, and plurality of compliance journey to fulfill any shortcomings or non-compliance and achieve target compliance state.

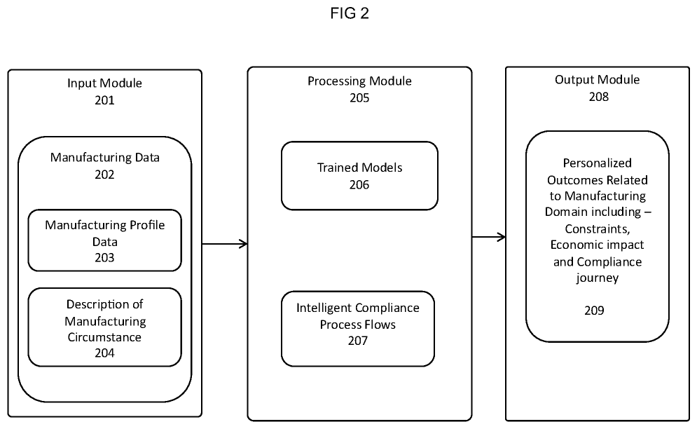

Referring to the drawings, FIG. 2 is a schematic view of a system for regulatory discovery and accelerated compliance for the Manufacturing industry domain according to an example embodiment. In the example embodiment of Manufacturing industry domain, input module 201 collects manufacturing input data 202: manufacturing profile data 203 and description of manufacturing circumstance 204. For example, description of manufacturing circumstance 204 may include manufacturing narrative data such as the notion of new product development, new raw materials, changes in production process, or addition of a new customer location, among others. The input manufacturing data 202 is then applied to a processing module 205, which includes trained models 206, trained with manufacturing data. Further the processing module 205 may include a plurality of intelligent manufacturing process flow 207. In particular, the trained models 206 output, to the output module 208, one or more personalized outcomes related to manufacturing domain 209. In one embodiment, personalized outcomes 209 may include constraints such as a list of rules and regulations applicable to the manufacturing profile data 203 and description of manufacturing circumstance 204. In another embodiment, personalized outcomes related to manufacturing domain 209 may include an estimated economic impact and plurality of compliance journey to fulfill any shortcomings or non-compliance and achieve target compliance state.

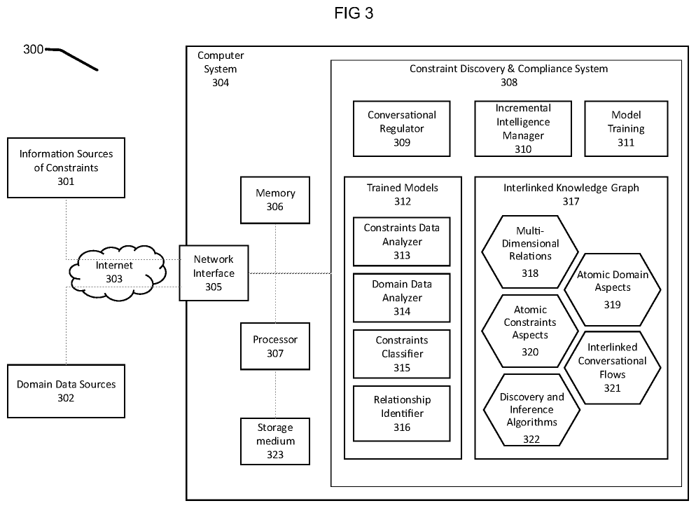

Referring to the drawings, FIG. 3 is a schematic view of the operating environment for processing data from information sources of constraints and domain data according to an example embodiment. In an exemplary embodiment the schematic view 300 may include a computer system 304, information sources of constraints 301, domain data sources 302, and network 303. For example, the internet can be used as a network medium. In one embodiment, information source of constraints 301 can be a government agency with regulatory requirements. In another embodiment, information source of constraints 301 can be an organization or company with organizational policies, rules, and principles. Examples of domain data source 302 may include business process data such as product manufacturing process, process for a service offering, process of procurement of products and services, among others. Domain data may also include business events such as addition of new business process, change in rules, policies or regulations, among others. The data from information source of constraints 301 and domain data sources 302 is received in uniform format by computer system 304 through internet 303 utilizing network interface 305. In one embodiment, the uniform format might be text format. In yet another embodiment, the uniform format might be voice or image or image containing text. The network interface 305 can accept various protocols including Internet Protocol (IP) and can transmit data from and to external entities. Computer system 304 includes a memory 306, storage medium 323, and a processor 307 which are configured to control its operation. Memory 306 may be configured to store data and computer-executable instructions associated with an operating system and constraints discovery & compliance system 308. Processor 307 may run the operating system and execute constraints discovery & compliance system 308.

Further in FIG. 3, constraints discovery & compliance system 308 may analyze profile data and description of circumstance, to determine personalized outcomes. In an exemplary embodiment the constraints discovery & compliance system 308 may include conversational regulator 309 which drives interactions with the user in a conversational manner. The conversational regulator 309 may utilize the interlinked conversational flows 321 with natural language processing (NLP) based trained models 312. In yet another embodiment the constraints discovery & compliance system 308 may include incremental intelligence manager 310 which drives cumulative upbuilding of graph based interlinked knowledge graph 317, trained models 312, interlinked knowledge graph 317. The constraints discovery & compliance system 308 may include a model training application 311 which is used to train models 312 and tune interlinked knowledge graph 317 based on historical domain data.

In yet another embodiment the trained models 312 may include constraints data analyzer 313 which uses custom NLP to build graph-like representation of constraints data obtained from information sources of constraints 301, domain data analyzer 314 which uses structural algorithms to build graph-like representation of domain data 302, constraints classifier 315 which uses neural network to classify the constraints against categories relevant to specific domain, and relationship identifier 316 which uses graph to define relationship of identified constraint classes with domain data sources 302. In one embodiment, structural representation of constraints data obtained from information sources of constraints 301 may include compliance category, product, regulated item, regulatory requirements, and compliance method, among others.

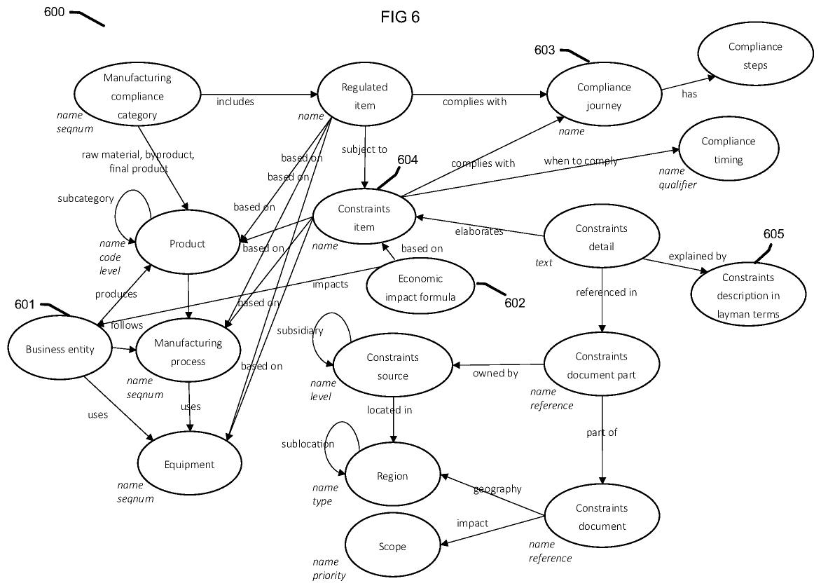

In yet another embodiment the constraints discovery & compliance system 308 may include an interlinked knowledge graph 317 which includes but not limited to multi-dimensional relations 318 with several layers of relations between constraints data and domain data, atomic domain aspects 319 with key domain specific terms and rules, atomic constraints aspects 320 with key constraint terms and inter-dependencies, interlinked conversational flows 321 with domain specific and intent based conversational flow frameworks, and discovery and inference algorithms 322 which may be utilized to infer new multi-dimensional relationships 318 between one or more atomic domain aspects 319 and one or more atomic constraint aspects 320. In one embodiment the machine models may be trained with domain specific terminology captured by atomic domain aspects 319 may improve classification of constraints against categories relevant to specific domain. In one embodiment the details of the interlinked knowledge graph 317 are further represented in FIG. 6.

Further as in FIG. 6, an exemplary model for a knowledge graph is illustrated. The model includes key concepts such as Business entity 601 with relations to Product, Manufacturing process, and Equipment. It also includes Constraints item 604 with relations to Constraints detail, Constraints description in layman terms 605, Economic impact formula 602, and Compliance journey 603. The diagram further elaborates the relationships with additional details that help traversing the knowledge graph with the minimal time while providing enough data to build compliance journey and come up with adequate explanation.

### II. Process Flow

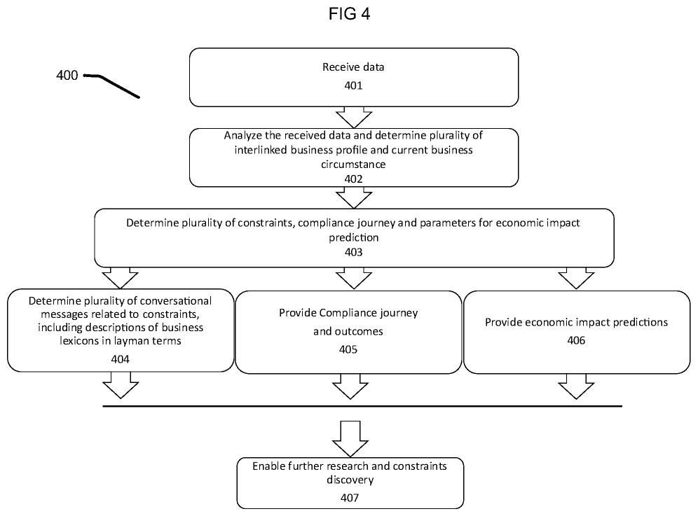

In an exemplary embodiment the Constraint discovery and compliance system 308 may be executed by the processor of the Computer system 304. FIG. 4 is a process flow for utilizing trained models to determine plurality of constraint aspects and compliance journeys with personalized outcomes, in a conversational manner.

The method 400 will be described in conjunction with the components of the schematic views and overall operating environment but it is understood that the steps of method 400 can be organized into different architectures, blocks, stages, and/or processes.

At block 401, the method 400 includes receiving data. In one embodiment the input data 102 may include information about entity profile 103 and a description of the circumstance 104 under consideration.

In one aspect a user or system can provide information about the circumstances using multiple channels of input, including but not limited to text messages, voice messages converted to text, and images, among others.

In one embodiment the method may provide a graphical user interface (GUI) that receives the data in a conversational manner, where the system asks questions and accepts user input.

At block 402, the method 400 includes analyzing the received data and determining a plurality of interlinked business profile and current business circumstance. The method 400 may analyze the received data using processes based on trained models 106 to classify and identify different aspects of the domain. The aspects identified may include but not limited to products, processes, customers, locations, among others. The method 400 may further analyze the received data and determine concepts from the received data, where concepts may include but not limited to circumstances such as introduction of new product, process, customer location, receipt of customer communication, among others. The method 400 may analyze the received data and determine the relationships that interlink domain aspects and concepts in multiple dimensions.

At block 403, the method 400 includes inputting the plurality of interlinked data, which may include interlinked domain aspects and concepts in multiple dimensions and determining plurality of interlinked constraints, compliance journey and parameters for economic impact prediction. The method 400 may analyze the input data from block 402 and determine one or more constraint aspects interlinked with one another and/or with the input data 102. In one embodiment a constraint aspect could be a set of rules or policies related to the input concept such as new customer location. The method 400 may analyze the input data from block 402 and determine one or more compliance journeys which when executed may lead to outcomes that satisfy identified constraints. In one embodiment a compliance journey may include a set of steps for data gathering and report submissions that lead to outcomes of complying with constraints such as rules and policies related to an input concept such as new customer location. In another embodiment the method 400 may analyze the input data from block 402 and determine parameters for economic impact predictions. The parameters may include the constraint source such as government agency name, revised taxation numbers, minimal labor pay, labor categories, material cost, among others.

At block 404, the method 400 includes determining plurality of conversational messages related to constraints that have been determined in block 403. In one embodiment the converted message may include a human readable description of the constraint aspects and business lexicons.

At block 407, the method 400 includes options for the user to do further research and constraints discovery. In one embodiment the options may include a way for the user to make further queries, then the system will receive the data and the process will start again at block 401 of method 400.

At block 405, the method 400 includes providing compliance journey and outcomes. In one embodiment the compliance journey may have multiple steps that receive data, process the received data, and generate an outcome. In another embodiment the compliance journey may include receiving data such as customer communication, profile and description of circumstance from an external system 302, processing the received data to identify and classify domain aspects, and provide reports as an outcome. In yet another embodiment the method provides compliance journeys which includes scheduled events incorporated into user's calendar. The system provides multiple views to represent scheduled events based on user preferences. In yet another embodiment the compliance journey may include task execution, progress monitoring, and providing necessary reminders, notifications, and status cataloging. In yet another embodiment the method 400 may provide outcomes that include prediction of compliance risk and comparison with standard risk calculation frameworks. In yet another embodiment the method 400 may provide outcomes that include recording of all compliance steps formatted as official audit records for both self-audit and external audit. In yet another embodiment of the method 400, the compliance journey may include ingestion of data in standard formats required for compliance submissions. In yet another embodiment of the method 400, the compliance journey may include but not limited to generation of audit reports, identification of countermeasures to ensure continued compliance, and execution of the counter-measure tasks.

At block 406, the method 400 includes providing economic impact predictions related to compliance and non-compliance of the business entity. In one embodiment the method provides estimation of the cost of compliance using existing and upcoming constraints by iterating through each constraint category and source, identifying corresponding scope of work, applying the cost of materials, labor categories and minimal labor pay, revised taxation numbers, and calculating both fixed and marginal compliance costs and cost-to-profit ratios. In another embodiment the method provides estimation of the cost of non-compliance using historical data and probabilistic approach.

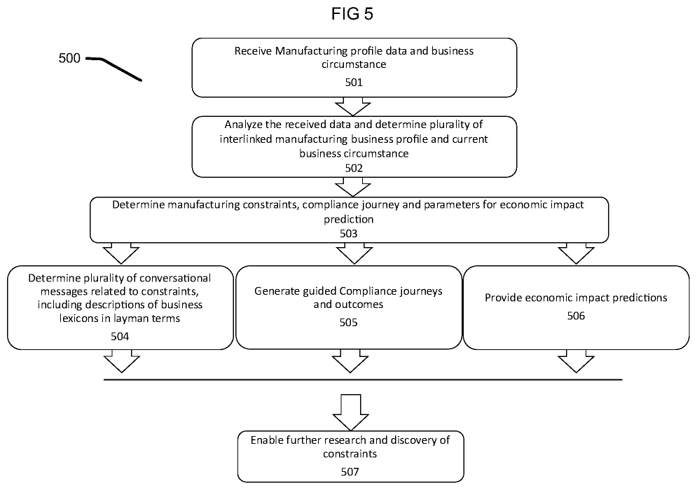

FIG. 5 represents an exemplary embodiment of the method for discovery of constraints and accelerating compliance as applied to the manufacturing domain. The method 500 will be described in conjunction with the schematic views and overall operating environment. It is understood that the method 500 is an exemplary embodiment, whereas the steps of method 500 can be organized into different architectures, blocks, stages and/or processes.

At block 501 the method 500 includes receiving manufacturing data. In one embodiment the received input data 202 may include several aspects of the manufacturing domain through manufacturing profile data 203 such as, raw materials, sourcing locations, production process, quality control process, labeling and packaging data, customer locations, distribution & shipment, post sales processes, and EH&S, among others, as well as the information about current circumstance of the entity, which may include new production lines, new customer locations, customer communications, complaints, and new product introduction, among others. The circumstantial data could vary for the manufacturing domain, and similar data could be included when the method is applied to a different industry domain.

At block 502 the method 500 includes analyzing the input data 202 and determining plurality of interlinked manufacturing aspects. In one embodiment the analysis process may use trained models 312, which may include NLP techniques, to identify manufacturing domain aspects and relationships that interlink domain aspects.

At block 503 the method 500 includes processing the plurality of interlinked manufacturing aspects to determine plurality of interlinked regulatory aspects and compliance journeys. In one embodiment the method may process the plurality of interlinked manufacturing aspects using trained models 312 to determine plurality of interlinked regulatory aspects relevant to the manufacturing domain.

At block 504 the method 500 includes determining plurality of conversational messages related to constraints that have been determined in block 503. In one embodiment the converted message may include a human readable description of the constraint aspects and business lexicons.

At block 507 the method 500 includes options for the user to do further research. In one embodiment the options may include a way for the user to query on the personalized outcome 209, which may be the interlinked regulatory aspects provided at block 504. The queries may include specific questions about a government agency, regulation, or other constraints provided.

At block 505, the method 500 includes providing compliance journey and outcomes for manufacturing domain. In one embodiment the compliance journey may include receiving data such as customer communication, profile and description of manufacturing circumstance using manufacturing narrative data from an external system 302, processing interlinked manufacturing regulatory aspects data using trained models 312 to identify and classify manufacturing domain aspects, among others, and provide reports as an outcome. In another embodiment the method provides compliance journeys which includes scheduled events incorporated into user's calendar. The system provides multiple views to represent scheduled events based on user preferences. In yet another embodiment the compliance journey may include task execution, progress monitoring, and providing necessary reminders, notifications, and status cataloging. In yet another embodiment the method 500 may provide outcomes that include prediction of manufacturing compliance risk and comparison with standard risk calculation frameworks. In yet another embodiment the method 500 may provide outcomes that include recording of all compliance steps formatted as official audit records for both self-audit and external audit. In yet another embodiment of the method 500, the compliance journey may include ingestion of data in standard formats required for compliance submissions to government agencies. In yet another embodiment of the method 500, the compliance journey may include but not limited to generation of audit reports, identification of countermeasures to ensure continued compliance, and execution of the counter-measure tasks.

At block 506 the method 500 includes providing economic impact predictions related to compliance and non-compliance of the manufacturing business entity. In one embodiment the method provides estimation of the cost of compliance using existing and upcoming constraints by iterating through each constraint category and source, identifying corresponding scope of work, applying the cost of materials, labor categories and minimal labor pay, revised taxation numbers, and calculating both fixed and marginal compliance costs and cost-to-profit ratios. In another embodiment the method provides estimation of the cost of non-compliance using historical data and probabilistic approach.

What is claimed is:

1. The computer-implemented method for discovery of constraints, predicting economic impact of constraints, and creation and traversal of compliance journey using virtual conversational assistant, comprising:
receiving input data from the user regarding business profile and business circumstances about a business entity;
applying the input data to pre-trained machine learning models to extract data related to manufacturing business profile and current business circumstance;
applying the manufacturing business profile and business circumstance data to a machine learning classifier trained using constraints definitions and business processes, to determine the first set of nodes in the knowledge graph representing constraints that the entity needs to comply with; the knowledge graph is pre-created with inter-linked data related to manufacturing business profile and constraints;
providing a response to the user utilizing the identified constraints;
presenting compliance journey to the user as conversational messages with one or more steps for the entity to comply with the identified constraints;
applying the manufacturing business profile, business circumstance data and identified constraints to an impact prediction engine that uses pre-determined formulas stored in the knowledge graph to predict economic impact of the identified constraints to the business entity;
presenting economic impact to the user as a conversational message relevant to the business profile, business circumstance, and identified constraints;
receiving input data from the user regarding at least one clarification about the presented constraints;
applying the input data received from user to a machine learning model trained to extract lexicons related to the presented constraints;
applying the identified lexicons related to constraints to a machine learning classifier trained using constraints definitions, to determine the second set of nodes in the knowledge graph, pre-created with inter-linked constraints data and descriptions of constraints in layman terms;
using the second set of nodes to provide a response to the user with the linked constraint descriptions.

2. The method of claim 1, further including description of an entity profile through aspects relevant to a business entity or user and business circumstance through general business circumstances such as new customer acquisition, new product, new location, or new facility, among others, and guided by conversational assistance wherein the input data can be in textual and voice formats, among others.

3. The method of claim 1, further including business entity profile data for manufacturing domain defined through raw materials, sourcing locations, production process, quality control process, labeling and packaging data, customer locations, distribution & shipment, post sales processes, and EH&S, among others, the business circumstance for manufacturing domain described by manufacturing narrative data, and interlinked constraint aspects for manufacturing domain with regulatory requirements from federal, state, local, and international jurisdictions, as well as international standards, company rules, policies, and standards, among others.

4. The method of claim 1, further including a pre-created knowledge graph. In one embodiment, knowledge graph may contain plurality of interlinked domain aspects, concepts, and constraints as determined using models trained on historical data, domain data, and constraints data.

5. The method of claim 1, further including compliance journey defined using scheduled events, event execution, progress monitoring, auditing, reminders, notifications, and status cataloging, among others, and guided by a virtual conversational assistant.

6. The method of claim 1, further including prediction of economic impact to a business entity due to compliance of existing and upcoming constraints; in one embodiment the economic impact may be defined using the ratio of estimated compliance cost to a business entity's gross profit, broken down by compliance types. In other embodiments the formula may include other parameters related to the business entity.

7. The method of claim 1, further including prediction of economic impact to a business entity due to non-compliance of constraints; in one embodiment the economic impact may be defined using historical data and probabilistic approach, broken down by compliance types.

8. The method of claim 1, further including lexicons defined as a mapping between business terms within business entity domains, constraints domains—and their descriptions in layman terms, pre-created in the knowledge graph. In one embodiment, the descriptions could be expansions to common abbreviations and other business terms.

9. The computer system for discovery of constraints, predicting economic impact of constraints, and creation and traversal of compliance journey using virtual conversational assistant, comprising:
a memory; and
at least one processor configured to access the memory and configured to perform operations comprising:
receiving input data from the user regarding business profile and business circumstances about a business entity;
applying the input data to pre-trained machine learning models to extract data related to manufacturing business profile and current business circumstance;
applying the manufacturing business profile and business circumstance data to a machine learning classifier trained using constraints definitions and business processes, to determine the first set of nodes in the knowledge graph representing constraints that the entity needs to comply with; the knowledge graph is pre-created with inter-linked data related to manufacturing business profile and constraints;
providing a response to the user utilizing the identified constraints;
presenting compliance journey to the user as conversational messages with one or more steps for the entity to comply with the identified constraints;
applying the manufacturing business profile, business circumstance data and identified constraints to an impact prediction engine that uses pre-determined formulas stored in the knowledge graph to predict economic impact of the identified constraints to the business entity;
presenting economic impact to the user as a conversational message relevant to the business profile, business circumstance, and identified constraints;
receiving input data from the user regarding at least one clarification about the presented constraints;
applying the input data received from user to a machine learning model trained to extract lexicons related to the presented constraints;
applying the identified lexicons related to constraints to a machine learning classifier trained using constraints definitions, to determine the second set of nodes in the knowledge graph, pre-created with inter-linked constraints data and descriptions of constraints in layman terms;
using the second set of nodes to provide a response to the user with the linked constraint descriptions.

10. The system of claim 9, wherein the processing device is further configured for processing description of an entity profile through aspects relevant to a business entity or user and business circumstance through general business circumstances such as new customer acquisition, new product, new location, or new facility, among others, and guided by conversational assistance wherein the input data can be in textual and voice formats, among others.

11. The system of claim 9, wherein the processing device is further configured for processing business entity profile data for manufacturing domain defined through raw materials, sourcing locations, production process, quality control process, labeling and packaging data, customer locations, distribution & shipment, post sales processes, and EH&S, among others, the business circumstance for manufacturing domain described by manufacturing narrative data, and interlinked constraint aspects for manufacturing domain with regulatory requirements from federal, state, local, and international jurisdictions, as well as international standards, company rules, policies, and standards, among others.

12. The system of claim 9, wherein the processing device is further configured for processing a pre-created knowledge graph. In one embodiment, knowledge graph may contain plurality of interlinked domain aspects, concepts, and constraints as determined using models trained on historical data, domain data, and constraints data.

13. The system of claim 9, wherein the processing device is further configured for processing compliance journey defined using scheduled events, event execution, progress monitoring, auditing, reminders, notifications, and status cataloging, among others, and guided by a virtual conversational assistant.

14. The system of claim 9, wherein the processing device is further configured for processing prediction of economic impact to a business entity due to compliance of existing and upcoming constraints; in one embodiment the economic impact may be defined using the ratio of estimated compliance cost to a business entity's gross profit, broken down by compliance types. In other embodiments the formula may include other parameters related to the business entity.

15. The system of claim 9, wherein the processing device is further configured for processing prediction of economic impact to a business entity due to non-compliance of constraints; in one embodiment the economic impact may be defined using historical data and probabilistic approach, broken down by compliance types.

16. The system of claim 9, wherein the processing device is further configured for processing lexicons defined as a mapping between business terms within business entity domains, constraints domains—and their descriptions in layman terms, pre-created in the knowledge graph. In one embodiment, the descriptions could be expansions to common abbreviations and other business terms.

17. The non-transitory computer readable storage medium storing computer executable instructions that when executed by a computer, which includes a processor perform a method, the method comprising:
receiving input data from the user regarding business profile and business circumstances about a business entity;
applying the input data to pre-trained machine learning models to extract data related to manufacturing business profile and current business circumstance;
applying the manufacturing business profile and business circumstance data to a machine learning classifier trained using constraints definitions and business processes, to determine the first set of nodes in the knowledge graph representing constraints that the entity needs to comply with; the knowledge graph is pre-created with inter-linked data related to manufacturing business profile and constraints;
providing a response to the user utilizing the identified constraints;
presenting compliance journey to the user as conversational messages with one or more steps for the entity to comply with the identified constraints;
applying the manufacturing business profile, business circumstance data and identified constraints to an impact prediction engine that uses pre-determined formulas stored in the knowledge graph to predict economic impact of the identified constraints to the business entity;
presenting economic impact to the user as a conversational message relevant to the business profile, business circumstance, and identified constraints;
receiving input data from the user regarding at least one clarification about the presented constraints;
applying the input data received from user to a machine learning model trained to extract lexicons related to the presented constraints;
applying the identified lexicons related to constraints to a machine learning classifier trained using constraints definitions, to determine the second set of nodes in the knowledge graph, pre-created with inter-linked constraints data and descriptions of constraints in layman terms;
using the second set of nodes to provide a response to the user with the linked constraint descriptions.
